(19) United States
(12) Patent Application Publication
(10) Pub. No.: US 2025/0074241 A1
(43) Pub. Date: Mar. 6, 2025

(54) CONTROL DEVICE FOR CHARGING FACILITY, CONTROL METHOD FOR CHARGING FACILITY, AND CHARGING SYSTEM

(71) Applicant: TOYOTA JIDOSHA KABUSHIKI KAISHA, Toyota-shi (JP)

(72) Inventor: Yutaka KUBOYAMA, Toyota-shi (JP)

(73) Assignee: TOYOTA JIDOSHA KABUSHIKI KAISHA, Toyota-shi (JP)

(21) Appl. No.: 18/772,503

(22) Filed: Jul. 15, 2024

(30) Foreign Application Priority Data
Aug. 30, 2023 (JP) 2023-139732

(51) Int. Cl. B60L 53/62; B60L 53/66; H02J 7/00

(52) U.S. Cl. CPC B60L 53/62; B60L 53/66; H02J 7/007182

(57) ABSTRACT

Electric Vehicle Supply Equipment determines the output power maximum value and the output current maximum value by using the voltage VB of the battery prior to starting the charge. The output power maximum value and the output current maximum value are set to be smaller when the voltage is low than when the voltage is high. The outputtable current value is calculated based on the maximum output power value, and the outputtable current value is set to be smaller when the voltage is low than when the voltage is high.

### CROSS-REFERENCE TO RELATED APPLICATION

This application claims priority to Japanese Patent Application No. 2023-139732 filed on Aug. 30, 2023, incorporated herein by reference in its entirety.

### BACKGROUND

### 1. Technical Field

The present disclosure relates to a control device for a charging facility, a control method for a charging facility, and a charging system.

### 2. Description of Related Art

Japanese Unexamined Patent Application Publication No. 2018-38198 (JP 2018-38198 A) discloses a vehicle including a power storage device that can be charged using an external power source. In JP 2018-38198 A, the power storage device is charged according to a command value that renders charging power smaller, of a charging current command value set according to an outputtable current of a charging station and a charging power command value set according to power required for the vehicle.

### SUMMARY

In JP 2018-38198 A, information on the outputtable current of the charging station is provided from the charging station to the vehicle. When a component designed for the vehicle is utilized (converted) for a component used for the charging station or the like, an output voltage of the charging station may not satisfy a lower limit voltage of a specification value (design value) of the charging station. When the output voltage of the charging station becomes a voltage lower than the lower limit output voltage, the charging current output from the charging station may be smaller than the outputtable current by limiting the output to an output that is allowable even at a low voltage. In this case, the charging current output from the charging station may deviate from the charging current command value, and charging may be stopped by a charging abnormality process.

An object of the present disclosure is to enable stable charging even when an output voltage of a charging facility becomes lower than a lower limit voltage.

An aspect of the present disclosure provides a control device for a charging facility that charges a battery mounted on a vehicle.

The control device is configured to transmit an outputtable current value that is outputtable from the charging facility to the vehicle.
The outputtable current value is set to be smaller when a battery voltage as a voltage of the battery is low than when the battery voltage is high.

According to this configuration, the control device for the charging facility transmits an outputtable current value that is outputtable from the charging facility to the vehicle. The outputtable current value is set to be smaller when the battery voltage is low than when the battery voltage is high. For example, the outputtable current value becomes smaller as the battery voltage becomes lower. Thus, the outputtable current value is small when the voltage (battery voltage) of the battery to be charged is low, and thus the range in which the battery can be charged is widened and the battery can be stably charged, even if the output voltage of the charging facility is lower than the lower limit voltage.

Preferably, the battery voltage may be a voltage of the battery before charging of the battery is started.

The control device may set the outputtable current value before the charging of the battery is started.

In general, the battery voltage before charging is started is lower than the battery voltage after charging is started. Thus, it is possible to suppress the outputtable current value becoming unnecessarily large, and to enable stable charging. The battery voltage before charging is started may be detected by a voltage sensor provided in the charging facility. At the start of charging, further, information on a normal lower limit voltage value of the battery may be transmitted from the vehicle before charging is started, and the normal lower limit voltage value may be used as the battery voltage before charging is started.

Preferably, the control device may reset the outputtable current value based on the battery voltage during the charging of the battery.

According to this configuration, the outputtable current value is reset based on the battery voltage during charging. When the battery voltage increases during charging, the outputtable current value becomes larger, and thus the charging time can be shortened.

An aspect of the present disclosure provides a control method for a charging facility that charges a battery mounted on a vehicle.

The control method includes: acquiring a battery voltage as a voltage of the battery before charging of the battery is started; and

transmitting an outputtable current value that is outputtable from the charging facility to the vehicle.
The outputtable current value is set to be smaller when the battery voltage is low than when the battery voltage is high.

According to this method, the battery voltage as the voltage of the battery before charging of the battery is started is acquired, and an outputtable current value that is outputtable from the charging facility is transmitted to the vehicle. The outputtable current value is set to be smaller when the battery voltage is low than when the battery voltage is high. Thus, the outputtable current value is small when the battery voltage is low, and thus the range in which the battery can be charged is widened and the battery can be stably charged, even when the output voltage of the charging facility is lower than the lower limit voltage.

An aspect of the present disclosure provides a charging system including:

a vehicle equipped with an externally chargeable battery;
a charging facility that supplies charging power to the battery; and
a control device that controls the charging facility.
The control device is configured to transmit an outputtable current value that is outputtable from the charging facility to the vehicle.
The outputtable current value is set to be smaller when a battery voltage as a voltage of the battery is low than when the battery voltage is high.
The vehicle sets a charging current command value based on the received outputtable current value, and transmits the charging current command value to the control device.
The control device controls the charging facility so as to supply the charging power to the battery based on the received charging current command value.

According to this configuration, the control device for the charging system transmits an outputtable current value that is outputtable from the charging facility to the vehicle. The vehicle sets a charging current command value based on the received outputtable current value, and transmits the charging current command value to the control device. The control device controls the charging facility so as to supply the charging power to the battery based on the received charging current command value. The outputtable current value is set to be smaller when the battery voltage is low than when the battery voltage is high. For example, the outputtable current value becomes smaller as the battery voltage becomes lower. Thus, the outputtable current value is small when the voltage (battery voltage) of the battery to be charged is low, and thus the range in which the battery can be stably charged is widened and the battery can be stably charged, even if the output voltage of the charging facility is lower than the lower limit voltage.

According to the present disclosure, it is possible to enable stable charging even when an output voltage of a charging facility becomes lower than a lower limit voltage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a charging system according to the present embodiment;

FIG. 2 is a diagram illustrating an exemplary charge initiation process performed in ECU;

FIG. 3 is an example of a map of an output power maximum value and an output current maximum value;

FIG. 4 is a sequence illustrating an example of a charge initiation process according to a modification; and

FIG. 5 is a flow chart illustrating an exemplary charging process executed in ECU.

### DETAILED DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

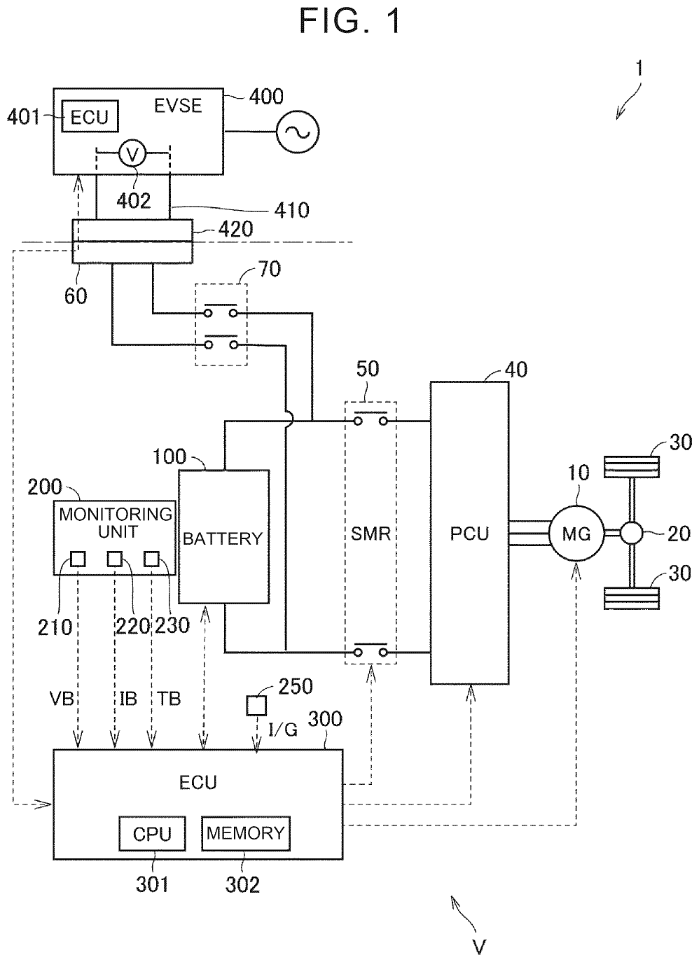

FIG. 1 is a diagram illustrating a configuration of a charging system 1 according to an embodiment of the present disclosure. The charging system 1 includes a vehicle V and an Electric Vehicle Supply Equipment (EVSE) 400. In the present embodiment, the vehicle V is, for example, battery electric vehicle (BEV) that does not include an internal combustion engine. However, the present disclosure is not limited thereto, and the vehicle V may be a plug-in hybrid electric vehicle (PHEV) including an internal combustion engine, or may be another electrified vehicle (xEV).

Vehicle V includes a Motor Generator (MG) 10 which is a rotary electric machine, power transmission gears 20, drive wheels 30, a Power Control Unit (PCU) 40, a System Main Relay (SMR) 50, a battery 100, a monitoring unit 200, and an Electronic Control Unit (ECU) 300.

MG 10 has a function as an electric motor and a function as a generator. The output-torque of MG 10 is transmitted to the drive wheels 30 via the power transmission gears 20 including a speed reducer, a differential, and the like.

When the vehicle V is braked, MG 10 is driven by the drive wheels 30, and MG 10 operates as a generator. As a result, MG 10 also functions as a braking device that performs regenerative braking for converting kinetic energy of the vehicle V into electric power. Regenerated electric power generated by regenerative braking force in the MG 10 is stored in the battery 100. The PCU 40 is a power conversion device that bidirectionally converts electric power between the MG 10 and the battery 100. The SMR 50 is electrically connected to power lines connecting the battery 100 and the PCU 40. When SMR 50 is ON, power is exchanged between the battery 100 and PCU 40.

The battery 100 stores electric power for driving MG 10. The battery 100 is a rechargeable DC power supply (secondary battery). The battery 100 is configured by, for example, stacking a plurality of unit cells (battery cells) and electrically connecting them in series.

The monitoring unit 200 includes a voltage sensor 210 that detects a voltage VB of the battery 100, a current sensor 220 that detects a current IB input to and output from the battery 100, and a temperature sensor 230 that detects a temperature TB of the battery 100.

ECU 300 includes Central Processing Unit (CPU) 301 and memories (e.g., Read Only Memory (ROM) and Random Access Memory (RAM)) 302, etc. ECU 300 controls the respective devices such that the vehicle V is in a desired condition based on the signals received from the monitoring unit 200, the signals from the various sensors (for example, the vehicle speed, the accelerator operation amount, and the like), the maps and the programs stored in the memories 302, and the like. For example, ECU 300 calculates State of Charge (SOC) of the battery 100 based on the signal received from the monitoring unit 200, and controls the charging and discharging of the battery 100 using this SOC. ON/OFF status of the ignition switch (power switch) 250 is inputted to ECU 300.

Vehicle V is provided with an inlet 60, and is configured to be connectable to a connector 420 provided at a distal end of EVSE 400 charge cable 410. The connector 420 is connected to the inlet 60, and the charging relay (CHR) 70 is closed to enable external charging of the battery 100 according to ECU 300 command. EVSE 400 includes, for example, a power converter that converts AC power supplied from a power system into DC power. EVSE 400 includes an ECU 401 that is a control device and a voltage sensor 402 that detects an outgoing voltage. ECU 401 includes a CPU and memories, and controls power outputted from EVSE 400 (charge power of the battery 100).

When the power switch 250 is turned OFF and EVSE 400 connector 420 is connected to the inlet 60, charging (external charging) of the battery 100 is started.

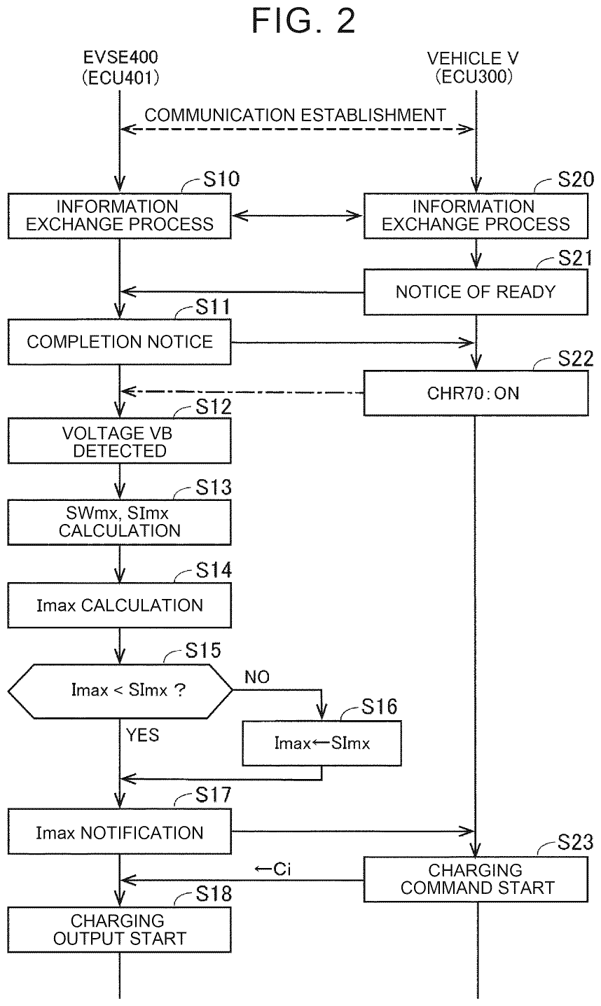

FIG. 2 is a diagram illustrating an exemplary charge starting process executed in ECU 300, 401. When the connector 420 is connected to the inlet 60, communication is established between ECU 401 and ECU 300. This communication may be Controller Area Network (CAN) communication and Power Line Communication (PLC) communication. The communication between ECU 401 and ECU 300 may be near field communication.

When communication between ECU 401 and ECU 300 is established, an information-exchanging process is performed (steps 10 and 20 (hereinafter, steps are abbreviated as “S”)). For example, the vehicle V (ECU 300) transmits the vehicle ID, the charging voltage upper limit value CVmx, the minimum-current charge value, the billing data, and the like to EVSE 400 (ECU 401). From EVSE 400 (ECU 401), the identifying ID, the version, the outputtable voltage value SVmx, the billing information, and the like are transmitted to the vehicle V (ECU 300).

When the information-exchanging process is completed and the vehicle V is ready to start charging, ECU 300 transmits a preparation completion notification to ECU 401 (S21). ECU 401 performs isolation diagnostics when it receives a readiness notification from ECU 300, and transmits a completion notification to ECU 300 when there is no anomaly (S11).

When the vehicle V (ECU 300) receives the completion notification, it ON CHR 70 (S22). EVSE 400 (ECU 401) detects the voltage VB of the battery 100 by the voltage sensor 402 after transmitting the completion notification (S12). Note that ECU 300 may be configured to transmit CHR 70′s ON notification, and ECU 401 may detect the voltage VB by the voltage sensor 402 after receiving ON notification. When CHR 70 is closed and no charge power is being outputted from EVSE 400, the voltage detected by the voltage sensor 402 is the voltage VB of the battery 100.

ECU 401 calculates an output power maximum value SWmx and an output current maximum value SImx based on the voltage VB detected by the voltage sensor 402 (S13).

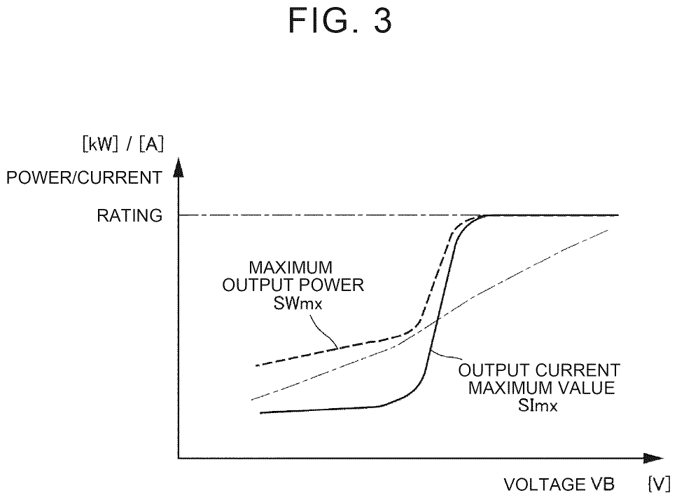

FIG. 3 is an exemplary map of the output power maximum value SWmx and the output current maximum value SImx. This map is stored in the memories of ECU401. S13 uses this map to calculate an output power maximum value SWmx (see dashed line) and an output current maximum value SImx (see solid line) based on the voltage VB. The output power maximum value SWmx and the output current maximum value SImx are set to be smaller (output is limited) when the voltage VB is low and when the voltage VB is high, as shown in FIG. 3. Note that the output power maximum value SWmx and the output current maximum value SImx may be set to be smaller as the voltage VB is lower, as indicated by a dashed-dotted line.

Referring back to FIG. 2, ECU 401 calculates an outputtable current Imax (S14). The outputtable current value Imax is calculated using the formula: “outputtable current value Imax=maximum output power value SWmx/min (charging voltage upper limit value CVmx, outputtable voltage value SVmx)” (S14). Min (charging voltage upper limit value CVmx, outputtable voltage value SVmx) is a smaller value of the charging voltage upper limit value CVmx and the outputtable voltage value SVmx.

When the outputtable current value Imax is larger than the output current maximum value SImx (when an affirmative determination is made in S15), ECU401 guards the outputtable current value Imax with the output current maximum value SImx (in S16, the outputtable current value Imax is set to the output current maximum value SImx).

Subsequently, ECU 401 notifies the vehicle V (ECU 300) of the outputtable current Imax (S17). When ECU 300 receives the outputtable current value Imax, it sets the charging current command value Ci. Then, ECU 300 transmits the charging current command value Ci to ECU 401, and starts the charging command (S23). The charging current command value Ci is a value less than or equal to the outputtable current value Imax, and may be set in accordance with, for example, the temperature TB of the battery 100.

When ECU 401 receives the charging current command value Ci (when the charging command is started), it starts outputting the charging power from EVSE 400. The current value of the charging power outputted from EVSE 400 is a charging current command value Ci. As a result, charging (external charging) of the battery 100 is started.

According to the present embodiment, EVSE 400′s ECU 401 transmits an outputtable current Imax that can be output from EVSE 400 to the vehicle V (ECU 300). The outputtable current value Imax is calculated using the formula: “outputtable current value Imax=maximum output power value SWmx/min (charging voltage upper limit value CVmx, outputtable voltage value SVmx)”. The output-power-maximum-value SWmx is set to be smaller when the voltage VB of the battery 100 is low than when the voltage VB is high (see FIG. 3). When the voltage VB of the battery 100 is low, the output current Imax is small, and therefore, even if the output voltage of EVSE 400 is lower than the lower limit voltage, the range in which the battery can be charged is widened and the battery can be charged stably.

Further, in the present embodiment, the output current maximum value SImx is also set to be smaller when the voltage VB of the battery 100 is low than when the voltage VB is high (see of FIG. 3). Since the output possible current value Imax is guarded by the output current maximum value SImx (see S15, S16), the output possible current value Imax becomes small even when the voltage VB of the battery 100 is low due to this configuration, even when the output voltage of EVSE 400 becomes lower than the lower limit voltage, the range that can be charged is expanded, and it is possible to stably charge.

In the present embodiment, the voltage VB for calculating the output power maximum value SWmx and the output current maximum value SImx is the voltage of the battery 100 detected by the voltage sensor 402 and prior to starting charging. The voltage VB prior to starting charging is lower than the voltage VB after starting charging. Therefore, it is possible to prevent the output power maximum value SWmx and the output current maximum value SImx from becoming unnecessarily large, and consequently, it is possible to prevent the output available current value Imax from becoming large, so that it is possible to stably charge.

### Modifications

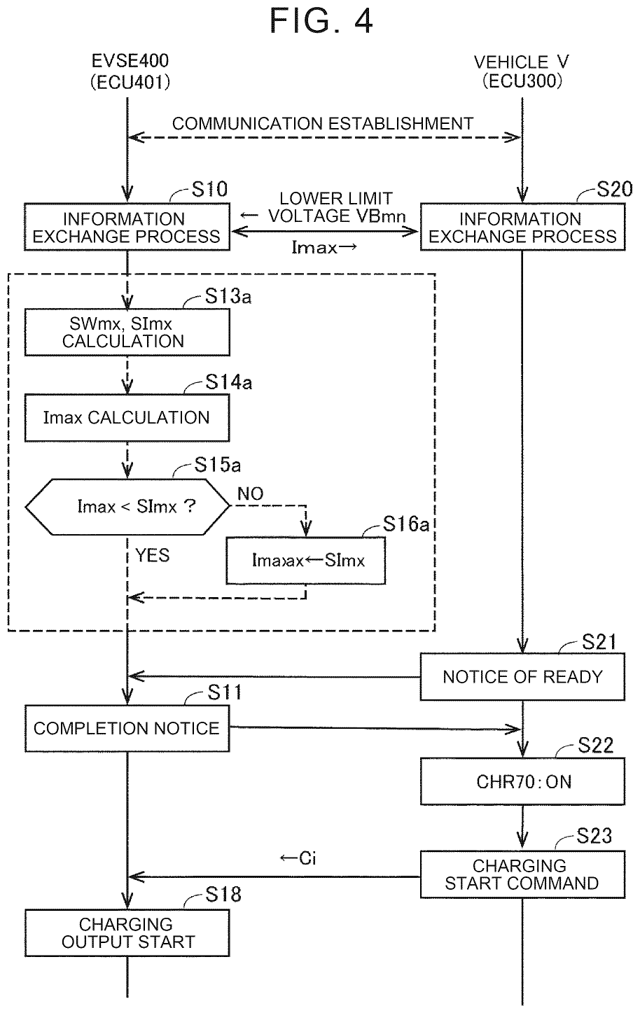

FIG. 4 is a sequence illustrating an example of a charge starting process according to a modification. In the above-described embodiment, the voltage VB prior to starting the charging is detected using the voltage sensor 402 provided in EVSE 400. In a modification, after communication between ECU 401 and ECU 300 is established, in the information-exchanging process, EVSE 400 (ECU 401) calculates the outputtable current Imax and transmits it to ECU 300.

In the information exchanging process (S10, 20) of the modification, information including the charging voltage upper limit value CVmx and the lower limit voltage value VBmn is transmitted from the vehicle V (ECU 300) to EVSE 400 (ECU 401). The lower limit voltage value VBmn is a value of the normal lower limit voltage of the battery 100, is set based on the specifications of the battery 100 and the vehicle V, and is stored in ECU 300 memory 302. The normal lower limit voltage of the battery 100 may be, for example, a voltage corresponding to a lower limit of a SOC during which normal running of the vehicle V is stopped (discharging from the battery 100 is stopped).

In the information exchange process of the modification, ECU 401 calculates the output power maximum value SWmx, the output current maximum value SImx, and the output available current value Imax using the received lower limit voltage value VBmn (S16a from S13a). S13a to S16a processing is the same processing as S13 to S16 processing, and the lower limit voltage value VBmn is used as the voltage VB, and the output current maximum value SImx and the output power maximum value SWmx are obtained from the map of FIG. 3 (S13a). Calculation formula: “Outputtable current value Imax=output power maximum value SWmx/min (charging voltage upper limit value CVmx, output voltage value SVmx)” is used to obtain the outputtable current value Imax, and the guard process is performed by the output current maximum value SImx (from S14a to S16a). Then, ECU 401 transmits the calculated outputtable current Imax to ECU 300 in addition to the identifying ID and the like.

In FIG. 4, the processes of S21, S11, S22, S23, and S18 are the same as the processes of S21, S11, S22, S23, and S18 in FIG. 3.

Also in this modification, in the vehicle V in which the lower limit voltage value VBmn is low and the voltage VB of the battery 100 is low, since the output available current value Imax is small as in the above-described embodiment, even if the output voltage of EVSE 400 becomes lower than the lower limit voltage, the range in which the battery can be charged is widened and the battery can be stably charged.

In the above-described embodiment, the outputtable current Imax is obtained by using the voltage VB prior to starting the charge. When the battery 100 is charged, the voltage VB increases. The charging current command value Ci is set to be equal to or less than the outputtable current value Imax. Therefore, during charging of the battery 100, the dischargeable current Imax may be reset in accordance with an increase in the voltage VB, thereby reducing the charging time.

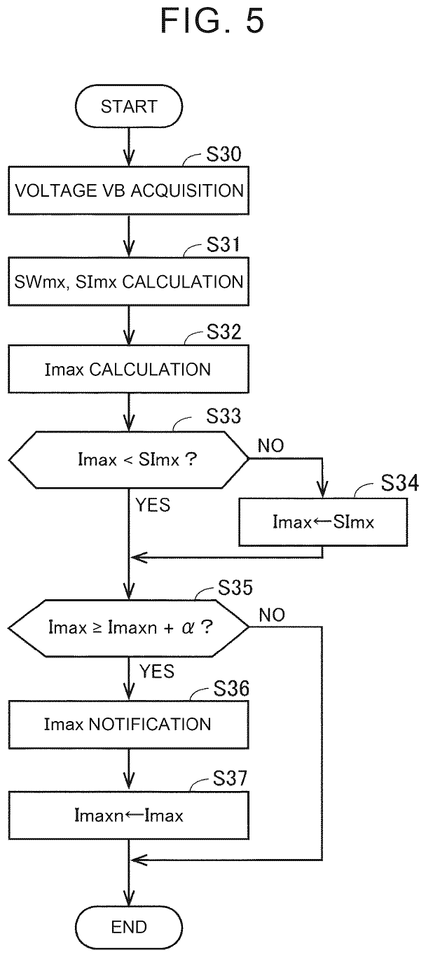

FIG. 5 is a flow chart illustrating an exemplary charging process executed in ECU 401. This flow chart is repeatedly processed at predetermined intervals while the battery 100 is charging (after S18 starts charging). For example, it is executed every time offset learning of the current sensor 220 of the monitoring unit 200 is performed. When the offset learning is executed, the charging of the battery 100 is temporarily stopped (the charging power becomes 0). In S17 of FIG. 2, the outputtable current value Imax notified to ECU 300 is stored in ECU401 as the present value Imaxn.

In FIG. 5, in S30, the voltage VB of the battery 100 is acquired. The voltage VB may be a value detected by the voltage sensor 402 or a voltage VB detected by the voltage sensor 210 of the monitoring unit 200.

In S31, the output power maximum value SWmx and the output current maximum value SImx are calculated based on the voltage VB acquired by S30. S31 process is the same as S13 (FIG. 2). In S32, the outputtable current value Imax is calculated, and in

S33, 34, the outputtable current value Imax is guarded by the output current maximum value SImx. S32, 33, 34 process is the same as the process of S14, 15, 16 (FIG. 2), and therefore the explanation thereof is omitted.

In S35, it is determined whether or not the outputtable current value Imax calculated by S34 from S31 is larger than the present value Imaxn stored in the memories by a predetermined value a or more. When the outputtable current value Imax is larger than the present value Imaxn by a predetermined value a or more (Imax≥Imaxn+α), the process proceeds to S36. When the outputtable current value Imax is not larger than the present value Imaxn by the predetermined value a or more (Imax<Imaxn+α), the present routine is ended. The predetermined value a may be set in advance in consideration of a detected error of the voltage VB or the like, and may be alpha=0.

In S36, ECU 300 is notified of the outputtable current Imax, and then the process proceeds to S37. In S37, after the current value Imax is stored in ECU 401 as the current value Imaxn (Imaxn←Imax), the present routine is terminated. When ECU 300 receives the outputtable current value Imax, it resets the charging current command value Ci. The charging current command value Ci is a value less than or equal to the outputtable current value Imax, and may be reset, for example, in accordance with the temperature TB of the battery 100. When the charging current command value Ci is reset, the charging power corresponding to the reset charging current command value Ci is outputted from EVSE 400.

By executing the charging process, the outputtable current Imax is reproduced and set based on the voltage VB during charging. When the voltage VB increases during charging, the value of the outputtable current value Imax increases, so that the charging time can be shortened.

The embodiment disclosed herein should be considered as illustrative and not restrictive in all respects. The scope of the present disclosure is defined not by the above description of the embodiments but by the claims, and is intended to include all possible modifications within a scope equivalent in meaning and scope to the claims.

What is claimed is:

1. A control device for a charging facility that charges a battery mounted on a vehicle, wherein:
the control device is configured to transmit an outputtable current value that is outputtable from the charging facility to the vehicle; and
the outputtable current value is set to be smaller when a battery voltage as a voltage of the battery is low than when the battery voltage is high.

2. The control device according to claim 1, wherein:
the battery voltage is a voltage of the battery before charging of the battery is started; and
the control device sets the outputtable current value before the charging of the battery is started.

3. The control device according to claim 2, wherein the control device resets the outputtable current value based on the battery voltage during the charging of the battery.

4. A control method for a charging facility that charges a battery mounted on a vehicle, the control method comprising:
acquiring a battery voltage as a voltage of the battery before charging of the battery is started; and
transmitting an outputtable current value that is outputtable from the charging facility to the vehicle, wherein the outputtable current value is set to be smaller when the battery voltage is low than when the battery voltage is high.

5. A charging system comprising:
a vehicle equipped with an externally chargeable battery;
a charging facility that supplies charging power to the battery; and
a control device that controls the charging facility, wherein:
the control device is configured to transmit an outputtable current value that is outputtable from the charging facility to the vehicle;
the outputtable current value is set to be smaller when a battery voltage as a voltage of the battery is low than when the battery voltage is high;
the vehicle sets a charging current command value based on the received outputtable current value, and transmits the charging current command value to the control device; and
the control device controls the charging facility so as to supply the charging power to the battery based on the received charging current command value.
